(19) United States
(12) Patent Application Publication
(10) Pub. No.: US 2007/0206343 A1
(43) Pub. Date: Sep. 6, 2007

(54) Electric double layer capacitor and method for manufacturing electric double layer capacitor

(75) Inventors: Hiroyoshi Take, Kobe-city (JP); Hiroshi Nonoue, Hirakata-city (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi (JP)

(21) Appl. No.: 11/708,340

(22) Filed: Feb. 21, 2007

(30) Foreign Application Priority Data
Feb. 22, 2006 (JP) P2006-045935

(51) Int. Cl. H01G 9/00

(52) U.S. Cl. 361/502

(57) ABSTRACT

An electric double layer capacitor includes electrodes mainly made of porous carbons. The electrodes include aggregates made of particles of metal or metal compound provided among the porous carbons. Moreover, holes are formed among the particles of metal or metal compound forming the aggregates.

### CROSS REFERENCE TO RELATED APPLICATIONS

This application is based upon and claims the benefit of priority from prior Japanese Patent Application No. 2006-45935, filed on February 22; the entire contents of which are incorporated herein by reference.

### BACKGROUND OF THE INVENTION

1. Field of the Invention

The present invention relates to an electric double layer capacitor including electrodes mainly made of porous carbons, and to a method for manufacturing the electric double layer capacitor.

2. Description of the Related Art

As a small and high-capacitance capacitor, an electric double layer capacitor is currently used as a back-up power supply or an auxiliary power supply of a portable telephone and a home appliance. The electric double layer capacitor generally includes a pair of electrodes, soaked in an electrolyte, provided with a separator sandwiched in between them. As to the electric double layer capacitor described above, besides an increase in a capacitance thereof, improvement in a capacitance retention rate is required so as not to reduce the capacitance even after long-time use thereof. In this respect, various configurations and various manufacturing methods of the electrodes are known for the improvement, since characteristics, such as the capacitance, of the electric double layer capacitor, are heavily dependent on a configuration of the electrodes.

For example, there has been proposed an electrode containing various highly conductive materials since activated carbons as a main component of the electrode only achieve a low conductivity. Japanese Patent Publication No. Heisei 10 (1998)-172870 discloses an electric double layer capacitor including electrodes fabricated by use of activated carbon fiber containing metal particles. Specifically, the activated carbon fiber is prepared by heat-treating a mixture of a precursor such as activated carbons and highly conductive metal particles in steam. In the electric double layer capacitor disclosed in Japanese Patent Publication No. Heisei 10 (1998)-172870, resistivity of the electrodes is reduced by allowing the activated carbons to contain the metal particles therein. Thus, characteristics of the electric double layer capacitor, such as charge and discharge capacitances, are improved.

In the electric double layer capacitor disclosed in Japanese Patent Publication No. Heisei 10 (1998)-172870 described above, the metal particles are contained in the activated carbon fiber. Thus, the activated carbon fiber are easily separated from each other in a case where expansion and contraction of the electrodes in charging and discharging cause a force to act on the activated carbon fiber. Accordingly, a current path between the activated carbons is cut off, and the separation from surrounding activated carbons increases activated carbons which do not contribute to the accumulation of charges. Thus, there is a problem that a capacitance retention rate of the electric double layer capacitor is significantly reduced after longtime use involving charging and discharging.

### SUMMARY OF THE INVENTION

In first aspect of the present invention, an electric double layer capacitor includes electrodes mainly made of porous carbons. The electrodes have aggregates made of particles of metal or metal compound provided among the porous carbons. Moreover, in the capacitor, holes are formed among the particles of metal or metal compound forming the aggregates.

In the first aspect of the present invention, a diameter average of the aggregates is preferably 0.1 μm or more and 20 μm or less.

In the first aspect of the present invention, the aggregates preferably contain iron or cobalt.

In a second aspect of the present invention, a method for manufacturing an electric double layer capacitor includes following steps. (1) Preparing a mixture of porous carbons and aggregates where particles of metal or metal compound are aggregated and holes are formed among the particles, by mixing the porous carbons and the particles, and then by performing heat treatment to a resultant mixture in an inert gas atmosphere. (2) Fabricating electrodes by use of the mixture.

In the second aspect of the present invention, the heat treatment of the mixture is preferably performed in the inert gas atmosphere at 500 degrees C. or more and 1000 degrees C. or less.

In the second aspect of the present invention, the particles of metal or metal compound are mixed in a proportion of 0.1 wt % or more and 10 wt % or less relative to the porous carbons.

### BRIEF DESCRIPTION OF THE DRAWINGS

FIG. 1 is a picture of an aggregate observed by use of a scanning electron microscope.

FIG. 2 is a cross-sectional view of an electric double layer capacitor according to an embodiment of the present invention.

FIG. 3 is a schematic diagram of a part of the aggregate.

FIG. 4 is a graph showing a result of electron probe microanalysis on the aggregate.

FIG. 5 is a graph for explaining a voltage drop.

FIG. 6 is a graph showing a relationship between the number of days of consecutive charge and a capacitance retention rate.

### DETAILED DESCRIPTION OF THE EMBODIMENTS

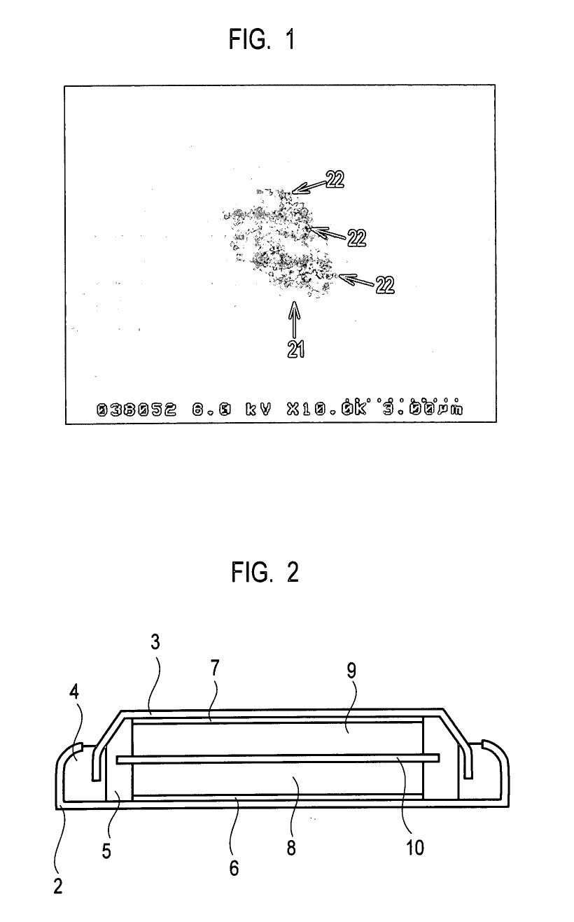

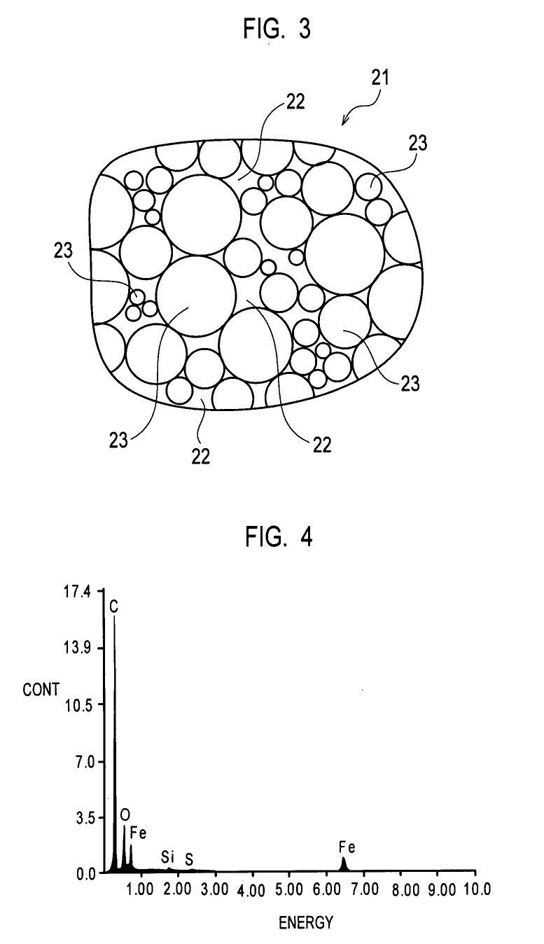

With reference to the drawings, embodiments of the present invention will be described below. FIG. 1 is a picture of an aggregate observed by use of a scanning electron microscope. FIG. 2 is a cross-sectional view of an electric double layer capacitor according to an embodiment of the present invention. FIG. 3 is a schematic diagram of a part of the aggregate.

As shown in FIG. 2, an electric double layer capacitor 1 includes lower and upper containers 2 and 3, a packing 4, an electrolyte 5, a pair of collectors 6 and 7, a pair of electrodes 8 and 9, and a separator 10.

The lower and upper containers 2 and 3 are sealed by caulking with the packing 4 interposed therebetween. The configuration of the lower and upper containers 2 and 3 is not particularly limited as long as the containers have resistance to the electrolyte and are highly airtight. For example, metal cans, containers made of resins or ceramics, and the like can be used as the containers.

The electrolyte 5 is housed in a closed space between the sealed lower and upper containers 2 and 3. As the electrolyte 5, one generally used as an electrolyte for a nonaqueous electrolyte secondary battery or an electric double layer capacitor can be used.

The pair of collectors 6 and 7 is immersed in the electrolyte 5 and provided on the upper surface of the lower container 2 and the lower surface of the upper container 3, respectively As a material of the collectors 6 and 7, a conductive material is applicable, such as platinum and aluminum.

The pair of electrodes 8 and 9 is immersed in the electrolyte 5 and provided while being separated into lower and upper parts by the separator 10. Each of the electrodes 8 and 9 contains porous carbons, a conductive agent, aggregates and a binder.

As the porous carbons, it is preferable to use powdered activated carbons easily mixed with aggregates made of metal or metal compound particles. Meanwhile, it is possible to use porous carbons made of activated carbon fiber, carbon nanotubes, exfoliated carbon fiber, carbonized polyvinylidene chloride or the like.

The conductive agent is for forming a current path between the porous carbons. As the conductive agent, carbon black, furnace black, acetylene black, Ketchen black or the like with a small particle diameter can be used.

As the binder, polytetrafluoroethylene (hereinafter referred to as PTFE), polyvinylidene fluoride or the like can be used.

The aggregate prevents separation of the porous carbons such as activated carbons from each other, has a function as the conductive agent, and is disposed so as to fit into a gap among the porous carbons. The aggregate is formed by aggregation of metal or metal compound particles and has holes formed among the particles. For example, in the case where a mixture of activated carbons and about 1 wt % of iron phthalocyanine (metal compound) relative to the activated carbons is subjected to heat treatment in an argon atmosphere at about 700 degrees C., an aggregate 21 having holes 22 among iron or iron compound particles 23 as shown in FIGS. 1 and 3, is formed in gaps among the activated carbons. Note that, in FIG. 1, a white cluster in the middle is the aggregate 21, and black dots in the aggregate 21 are the holes 22. Moreover, granular or fibrous substances around the aggregate 21 are the activated carbons.

Note that, the aggregate is not limited to the configuration described above, it is preferable to form the aggregate so as to have a diameter of about 0.1 μm or more and 20 μm or less. Moreover, the metal or metal compound which forms the particles preferably contains iron or cobalt.

As the separator 10, one made of polyolefin, cellulose fiber, glass fiber or the like can be used.

Next, description will be given of a method for manufacturing the electric double layer capacitor described above.

(Preparation of Mixture)

First, porous carbons such as powdered activated carbons having a specific surface area of about 960 m² to 2000 m² and a predetermined proportion of metal or metal compounds relative to the porous carbons are mixed by use of a mortar. Thereafter, the mixed sample is heat-treated in a high temperature inert gas atmosphere. As described above, the mixture of the porous carbons and the metal or metal compounds is heat-treated in an argon gas atmosphere that is the inert gas. Thus, metal or metal compound particles 23 are aggregated to form an aggregate 21 having holes 22 among the particles 23, as shown in FIGS. 1 and 3.

(Fabrication of Electrodes)

Next, the heat-treated mixture, a conductive agent and a binder are mixed and kneaded into a sheet. Thereafter, by shaping the sheet into a desired shape, electrodes 8 and 9 are completed.

(Manufacture of Electric Double Layer Capacitor)

By vapor deposition or the like, a collector 6 is previously formed on a lower container 2 or the electrode 8. Next, by use of carbon paste, the electrode 8 is adhered to the lower container 2 with the collector 6 interposed therebetween. Furthermore, a separator 10 is disposed on the electrode 8. Next, an electrolyte 5 is injected into the lower container 2, and by vacuum impregnation in this state, the electrode 8 and the separator 10 are sufficiently impregnated with the electrolyte 5. Thereafter, a packing 4 is provided in a peripheral portion of the lower container 2. Subsequently, by use of carbon paste, an electrode 9 is adhered to an upper container 3 with a collector 7 interposed therebetween, the collector 7 being formed in the same manner as the collector 6. Thereafter, by placing the upper container 3 on the lower container 2 and caulking and sealing the peripheral portion where the packing 4 is provided, an electric double layer capacitor 1 shown in FIG. 2 is completed.

As described above, the electric double layer capacitor 1 according to the present invention includes the electrodes 8 and 9, each having the aggregate 21 which is made of metal or metal compound particles and has the holes 22 formed therein. Thus, in a case where expansion and contraction in charging and discharging cause a force to act on the aggregate 21, the force can be absorbed by the holes 22. Therefore, even if the porous carbons around the aggregate 21 are deformed by the force, the aggregate 21 can also be deformed in accordance with deformation of the porous carbons. Thus, it is possible to suppress separation between the aggregate 21 and the porous carbons and separation between the porous carbons. Accordingly, it is possible to suppress an increase of porous carbons such as activated carbons which are separated from surrounding aggregates 21 or porous carbons, and which do not contribute to the accumulation of charges. Thus, reduction in the capacitance retention rate of the electric double layer capacitor 1 can be suppressed.

Moreover, by suppressing the separation between the aggregate 21 and the porous carbons and the separation between the porous carbons, reduction in a current path can be suppressed. Thus, an increase in resistance can be suppressed. As a result, it is possible to suppress a change in voltage drop after long-time use.

Moreover, the formation of the holes 22 in the aggregate 21 makes it possible to reduce a weight per unit volume of the aggregate 21 and to suppress a weight increase in the electrodes 8 and 9, and to accelerate the impregnation of the electrolyte 5 into the electrodes 8 and 9.

### EXAMPLES

Next, description will be given of experiments conducted to verify the effects described above.

(Experiment 1) Effect of Aggregate

First, description will be given of an experiment conducted to verify the effect of including the aggregates in the electrodes on the improvement of the capacitance retention rate.

First, Examples 1 and 2 according to the present invention, which are prepared for conducting the experiment, Comparative Examples 1 to 3 prepared for comparison with Examples 1 and 2, and manufacturing steps thereof will be described.

As to Example 1, a mixture was prepared by mixing activated carbons having a specific surface area of about 2000 m² and about 1.0 wt % of iron phthalocyanine relative to the activated carbons. Thereafter, the mixture was heat-treated in an argon atmosphere at about 700 degrees C. to prepare aggregates. Note that the aggregate shown in FIG. 1 is that of Example 1.

Next, as a conductive agent and a binder, about 10 wt % of acetylene black relative to the mixture and about 10 wt % of PTFE relative to the mixture were mixed with the heat-treated mixture, respectively, and kneaded into a sheet. By shaping the sheet into a disk shape having a diameter of about 2.2 mm and a thickness of about 0.5 mm, electrodes were fabricated.

An electrolyte was prepared by dissolving (C₂Hs)NBF₄ as a solute in propylene carbonate as a solvent so as to have a molar concentration of about 1 mol/l. Next, in a state where a lower collector, a lower electrode and a separator were placed in a lower container, the electrolyte was injected, therein and the electrode and the separator were vacuum-impregnated with the electrolyte at a pressure of about 40 kPa for about 30 seconds. Thereafter, an upper container having an upper collector and an upper electrode attached thereto was placed on the lower container, and the both containers were sealed. Thus, a coin-shaped electric double layer capacitor of Example 1 having a diameter of about 4.0 mm and a thickness of about 1.4 mm was manufactured.

As to Example 2, an electric double layer capacitor was manufactured in the same manner as that of Example 1, except that mixture was prepared by using about 1.0 wt % of cobalt phthalocyanine relative to the activated carbons instead of the iron phthalocyanine used in Example 1 described above.

As to Comparative Example 1, an electric double layer capacitor was manufactured in the same manner as that of Example 1, except that electrodes were fabricated by use of activated carbons without mixing any of metal and metal compound therewith and without heat-treating the activated carbons.

As to Comparative Example 2, an electric double layer capacitor was manufactured in the same manner as that of Example 1, except that activated carbons having neither metal nor metal compound mixed therewith were heat-treated in an argon atmosphere at about 700 degrees C.

As to Comparative Example 3, an electric double layer capacitor was manufactured in the same manner as that of Example 1, except that a mixture was prepared by mixing the activated carbons and about 1.0 wt % of iron phthalocyanine relative to the activated carbons without heat-treatment of the resultant mixture. Note that, in Comparative Example 3, unlike Examples 1 and 2, iron phthalocyanine in the mixture does not become an aggregate but remains as particles by omitting the step of heat-treating the mixture.

First, FIG. 4 shows a result of electron probe microanalysis on the aggregate of Example 1. In FIG. 4, the horizontal axis indicates characteristic X-ray energy, and the vertical axis indicates a count of characteristic X-ray. It is found out from FIG. 4 that the aggregate contains iron.

Next, description will be given of a method for experiments conducted to examine changes in a capacitance retention rate and a voltage drop.

First, each of the electric double layer capacitors manufactured in Examples 1 and 2 and Comparative Examples 1 to 3 described above was placed in a constant thermostatic chamber at about 25 degrees C. and charged to about 3.3 V. Thereafter, the capacitor was discharged to about 2.0 V. Moreover, a discharge capacitance was measured based on time required for the discharge, and was set as an initial discharge capacitance. Subsequently, a voltage of about 3.3 V was applied to the capacitor, and this voltage applied state was maintained. This state will be hereinafter referred to as a “consecutive charge state.” The voltage application was temporarily suspended after 10 days, after 20 days and after 30 days, and the capacitor was discharged to about 2.0 V. Moreover, a discharge capacitance was measured based on time required for the discharge. Accordingly, capacitance retention rates of the respective discharge capacitances with respect to the initial discharge capacitance were obtained.

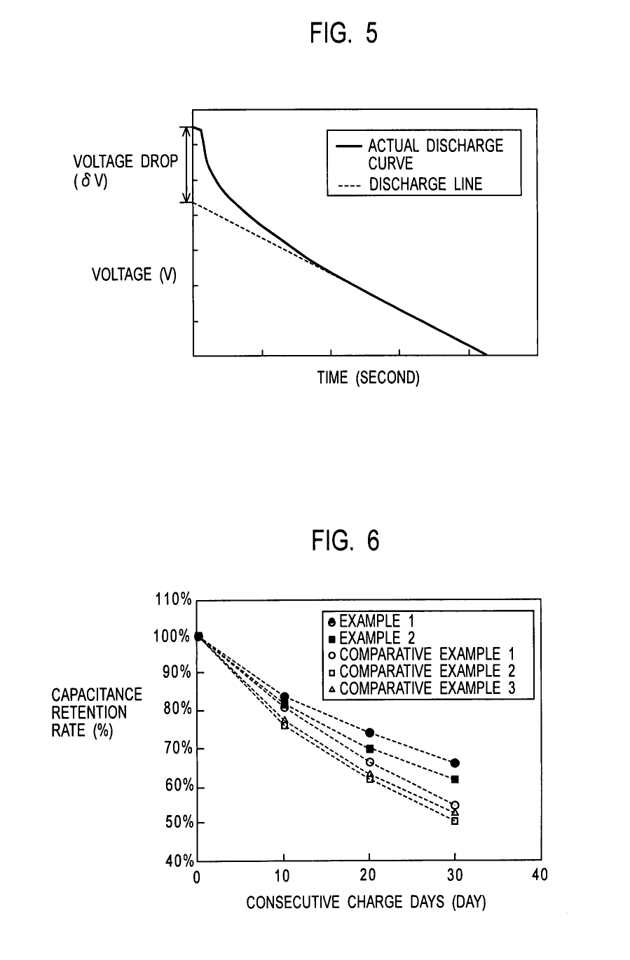

Moreover, in the charge and discharge experiments described above, an initial voltage drop δ V and a voltage drop δ V after 30 days were also obtained. In this respect, as shown in FIG. 5, the voltage drop δ V is a difference between a voltage obtained by linearly approximating a portion between about 2.5 V to 2.0 V of an actually measured discharge curve and extrapolating the approximated value until a discharge start time, and an actual voltage when discharge is started.

Table 1 shows the capacitance retention rates and the voltage drops, which were obtained from the experiments described above, and FIG. 6 shows the capacitance retention rates. Note that, in FIG. 6, the vertical axis indicates the capacitance retention rate (%) of the discharge capacitance after charge and discharge were performed for a predetermined period to the initial discharge capacitance. Moreover, the horizontal axis indicates the number of days of consecutive charge.

TABLE 1

| | CAPACI- | | |
|---|---|---|---|
| | TANCE | VOLTAGE DROP(V) | |
| | RETENTION | BEFORE | AFTER |
| | RATE AFTER | CONSECUTIVE | CONSECUTIVE |
| | 30 DAYS(%) | CHARGE | CHARGE |
| EXAMPLE 1 | 66 | 0.09 | 0.29 |
| EXAMPLE 2 | 62 | 0.09 | 0.38 |
| COMPARATIVE | 55 | 0.09 | 0.43 |
| EXAMPLE 1 | | | |
| COMPARATIVE | 51 | 0.10 | 0.48 |
| EXAMPLE 2 | | | |
| COMPARATIVE | 53 | 0.10 | 0.44 |
| EXAMPLE 3 | | | |

As shown in FIG. 6, in all of Examples 1 and 2 and Comparative Examples 1 to 3, the capacitance retention rates are reduced as the consecutive charge days are increased. However, it is found out that reductions in the capacitance retention rates of Examples 1 and 2 according to the present invention are smaller than those of Comparative Examples 1 to 3. Particularly it is found out that the longer the capacitors are used, the larger the differences in the reduction of the capacitance retention rate between Comparative Examples 1 to 3 and Examples 1 and 2 according to the present invention. With reference to Table 1, the capacitance retention rates after 30 days will be described below.

As shown in Table 1, the capacitance retention rates after 30 days of Examples 1 and 2 according to the present invention were about 62% or more. Meanwhile, the capacitance retention rates after 30 days of Comparative Examples 1 to 3 were about 55% or less. This result shows the following. Specifically, in Examples 1 and 2 according to the present invention, it is possible to suppress the reduction in the discharge capacitance even if the voltage was applied for a long time. On the other hand, in Comparative Examples 1 to 3, the discharge capacitances were significantly reduced.

In Examples 1 and 2 according to the present invention, the reduction in the discharge capacitance was able to be suppressed for the following reason. Specifically, since each of the electrodes includes the aggregates having holes, even if expansion and contraction caused by charging and discharging cause a force to act on the electrode, the force can be absorbed by the aggregates. Thus, even after long-time use, it is possible to suppress the separation between the activated carbons and the aggregates and the separation between the activated carbons. As a result, in Examples 1 and 2, even after long-time use, it is possible to suppress an increase of activated carbons which do not contribute to the accumulation of charges.

Meanwhile, in Comparative Examples 1 to 3, the capacitance retention rates were reduced for the following reason. Specifically, the capacitors include the electrodes made of the activated carbons containing neither metal nor metal compound (Comparative Examples 1 and 2), or the activated carbons containing metal particles (Comparative Example 3). Thus, if expansion and contraction cause a force to act on the electrodes, the force cannot be absorbed. Therefore, the electrodes are easily deformed, and the activated carbons are likely to be separated among one another. Consequently, activated carbons which do not contribute to the accumulation of charges, are significantly increased after long-time use. Thus, it is difficult to maintain the initial discharge capacitance and to suppress the reduction in the discharge capacitance after longtime use.

Moreover, as shown in Table 1, in Examples 1 and 2 according to the present invention, a difference between the initial voltage drop δ V and the voltage drop δ V after 30 days is about 0.29 V or less. Meanwhile, in Comparative Examples 1 to 3, a difference between the initial voltage drop δ V and the voltage drop δ V after 30 days is about 0.33 V or more. This is considered to be because of the following reason. Specifically, as described above, in Examples 1 and 2, the aggregates having holes can suppress the separation between the activated carbons and the separation between the activated carbons and the aggregates. Thus, even after long-time use, it is possible to suppress reduction of the current path and an increase in resistance. Meanwhile, in Comparative Examples 1 to 3, it is considered that the voltage drop δ V after long-time use is increased because of the following reason. Specifically, since the activated carbons are easily separated from each other, the current path is cut off and the resistance is easily increased.

(Experiment 2) Relationships Between Diameter Average of Aggregate, Initial Discharge Capacitance and Capacitance Retention Rate

Next, aggregates having different diameter averages were prepared to examine relationships between the diameter average of the aggregate, the initial discharge capacitance and the capacitance retention rate.

First, description will be given of manufacturing methods for electric double layer capacitors of Examples 3 to 10 prepared for the experiment described above. In the step of preparing the mixture of the activated carbons and the aggregate in the manufacturing method for Example 1 described above, about 0.05 wt % (Example 3), about 0.1 wt % (Example 4), about 1 wt % (Example 5), about 2 wt % (Example 6), about 3 wt % (Example 7), about 5 wt % (Example 8), about 10 wt % (Example 9), and about 15 wt % (Example 10) of iron phthalocyanine and activated carbons were mixed to prepare mixtures. Thereafter, the mixtures were heat-treated in an argon atmosphere at about 700 degrees C. Subsequently, electric double layer capacitors of Examples 3 to 10 were manufactured by performing the same steps as those in the manufacturing method for the electric double layer capacitor of Example 1 described above.

First, electrodes fabricated in Examples 3 to 10 were observed by use of a scanning electron microscope to examine diameter averages of aggregates included in the electrodes of the respective examples. Next, after the electric double layer capacitors of Examples 3 to 10 were charged to about 3.3 V, the capacitors were discharged to about 2.0 V to obtain initial discharge capacitances. Thereafter, a voltage of about 3.3 V was applied, and this state was maintained for 30 days. Subsequently, after the capacitors were discharged to about 2.0 V, and discharge capacitances after 30 days were measured. Then, capacitance retention rates of the discharge capacitances after 30 days relative to the initial discharge capacitances were obtained. Table 2 shows the results.

TABLE 2

| | | CAPACITANCE | AVERAGE |
|---|---|---|---|
| | INITIAL | RETENTION | DIAMETER OF |
| | DISCHARGE | RATE AFTER | AGGREGATE |
| | CAPACITANCE | 30 DAYS(%) | (μm) |
| EXAMPLE 3 | 19 | 59 | 0.08 |
| EXAMPLE 4 | 20 | 60 | 0.2 |
| EXAMPLE 5 | 20 | 66 | 2 |
| EXAMPLE 6 | 20 | 65 | 5 |
| EXAMPLE 7 | 20 | 62 | 8 |
| EXAMPLE 8 | 19 | 63 | 10 |
| EXAMPLE 9 | 19 | 62 | 18 |
| EXAMPLE 10 | 18 | 62 | 21 |

As shown in Table 2, in Examples 4 to 10 where the diameter averages of the aggregates were about 0.2 μm or more, the capacitance retention rates after 30 days were set as high as about 60% or more. Meanwhile, in Example 3 where the diameter average of the aggregate was about 0.08 μm, the capacitance retention rate was set as low as about 59%. This is considered to be because of the following reason. Specifically, the aggregates of Examples 4 to 10 can sufficiently absorb an external pressure and the like since enough holes are formed therein. On the other hand, the aggregate of Example 3 having a small diameter average does not have enough holes formed therein and thus cannot sufficiently fulfill a function of absorbing a force acting on the aggregate.

Moreover, in Examples 3 to 9 where the diameter averages of the aggregates were about 18 μm or less, the initial discharge capacitances were about 19 μAh or more. Meanwhile, in Example 10 where the diameter average of the aggregate was about 21 μm, the initial discharge capacitance was set as low as about 18 μAh. This reason is considered as follows. Specifically, in Example 10, the initial discharge capacitance was lowered because the proportion of the aggregates in the electrodes was too large and the proportion of the activated carbons was small.

As a result, it was found out that an electric double layer capacitor capable of improving the capacitance retention rate as well as the initial discharge capacitance can be realized by providing electrodes including aggregates having a diameter average of about 0.2 μm to 18 μm, which are prepared by use of about 0.1 wt % to 10 wt % of iron phthalocyanine relative to activated carbons.

(Experiment 3) Relationships Between Heat Treatment Temperature for Mixture of Activated Carbon and Metal Compound, Initial Discharge Capacitance, and Capacitance Retention Rate

Next, examined were relationships between the temperature of heat treatment for the mixture of the activated carbon and the metal compound in the steps of manufacturing the electric double layer capacitor described above, the initial discharge capacitance, and the capacitance retention rate.

First, description will be given of manufacturing methods for electric double layer capacitors of Examples 11 to 18 prepared for the experiment described above. After activated carbons and about 1 wt % of iron phthalocyanine were mixed to prepare mixtures as in the case of Example 1, the mixtures were heat-treated in an argon atmosphere at about 300 degrees C. (Example 11), about 450 degrees C. (Example 12), about 500 degrees C. (Example 13), about 700 degrees C. (Example 14), about 900 degrees C. (Example 15), about 1000 degrees C. (Example 16), about 1100 degrees C. (Example 17), and about 1300 degrees C. (Example 18). The other manufacturing steps are the same as those of Example 1 described above.

Thereafter, as in the case of Experiment 2, initial discharge capacitances and capacitance retention rates of discharge capacitances after 30 days relative to the initial discharge capacitances were obtained. Table 3 shows the results.

TABLE 3

| | INITIAL | CAPACITANCE |
|---|---|---|
| | DISCHARGE | RETENTION |
| | CAPACITANCE | RATE |
| | (μAh) | AFTER 30 DAYS(%) |
| EXAMPLE 11 | 20 | 57 |
| EXAMPLE 12 | 21 | 58 |
| EXAMPLE 13 | 20 | 64 |
| EXAMPLE 14 | 20 | 66 |
| EXAMPLE 15 | 20 | 66 |
| EXAMPLE 16 | 19 | 67 |
| EXAMPLE 17 | 17 | 70 |
| EXAMPLE 18 | 13 | 85 |

As shown in Table 3, in Examples 13 to 18 where the temperatures of heat treatment of the mixtures were set about 500 degrees C. or more, the capacitance retention rates were set as high as about 64% or more.

Meanwhile, in Examples 11 and 12 where the temperatures of heat treatment of the mixtures were set about 450 degrees C. or less, the capacitance retention rates were set as low as about 58% or less.

Moreover, in Examples 11 to 16 where the temperatures of heat treatment of the mixtures were set to about 1000 degrees C. or less, the initial discharge capacitances were set as high as about 19 μAh or more. Meanwhile, in Examples 17 and 18 where the temperatures of heat treatment of the mixtures were set to about 1100 degrees C. or more, the initial discharge capacitances were set as low as about 16 u Ah or less. This is considered to be because the heat treatment performed at a high temperature changed the activated carbons in the mixtures and the specific surface area of the activated carbons was reduced.

As a result, it was found out that an electric double layer capacitor capable of improving the capacitance retention rate as well as the initial discharge capacitance can be manufactured by setting the temperature of heat treatment of the mixture at about 500 degrees C. to 1000 degrees C.

Although the present invention has been described in detail above by use of the embodiments, it is apparent to those skilled in the art that the present invention is not limited to the embodiments described in the present specification. The present invention can be implemented as altered and modified embodiments without departing from the spirit and scope of the present invention as defined by the description of claims. Therefore, the description of the present specification is for illustrative purposes and is not intended to limit the present invention in any way.

What is claimed is:

1. An electric double layer capacitor comprising:
electrodes mainly made of porous carbons, and include aggregates made of particles of metal or metal compound provided among the porous carbons,
wherein holes are formed among the particles of metal or metal compound forming the aggregates.

2. The electric double layer capacitor according to claim 1, wherein a diameter average of the aggregates is 0.1 μm or more and 20 μm or less.

3. The electric double layer capacitor according to claim 1, wherein the aggregates contain any of iron and cobalt.

4. A method for manufacturing an electric double layer capacitor, comprising the steps of:
preparing a mixture of porous carbons and aggregates where the particles of metal or metal compound are aggregated and where holes are formed among the particles, by mixing the porous carbons and the particles, and then by performing heat treatment to a resultant mixture in an inert gas atmosphere; and
fabricating electrodes by use of the mixture.

5. The method for manufacturing an electric double layer capacitor according to claim 4, wherein the heat treatment of the resultant mixture is performed in the inert gas atmosphere at 500 degrees C. or more and 1000 degrees C. or less.

6. The method for manufacturing an electric double layer capacitor according to claim 4, wherein the particles of metal or metal compound are mixed in a proportion of 0.1 wt % or more and 10 wt % or less relative to the porous carbons.
